(19) United States
(12) Patent Application Publication
(10) Pub. No.: US 2010/0316424 A1
(43) Pub. Date: Dec. 16, 2010

(54) CLEANING BLADE FOR IMAGE-FORMING APPARATUS

(76) Inventor: Mutsuki Sugimoto, Hyogo (JP)

Correspondence Address: BIRCH STEWART KOLASCH & BIRCH, PO BOX 747, FALLS CHURCH, VA, 22040-0747, US

(21) Appl. No.: 12/866,677

(22) PCT Filed: Feb. 6, 2009
(86) PCT No.: PCT/JP2009/052068

§ 371 Date: Aug. 6, 2010

(30) Foreign Application Priority Data
Feb. 8, 2008 (JP) 2008-029465

(51) Int. Cl. G03G 21/00

(52) U.S. Cl. 399/350

(57) ABSTRACT

A cleaning blade for image-forming apparatuses is provided which is reduced in the coefficient of friction to attain a shortened slipping distance and thereby produce excellent cleaning performance. The cleaning blade can be easily produced at low cost. The cleaning blade for image-forming apparatus is formed from a thermoplastic elastomer comprising: a rubber ingredient comprising any one of a hydrogenerated acrylonitrile-butadiene rubber (HNBR), carboxylated acrylonitrile-butadiene rubber (XNBR), hydrogenerated carboxylated acrylonitrile-butadiene rubber (HXNBR), styrene-butadiene rubber (SBR), and ethylene/propylene/diene copolymer rubber (EPDM); and a thermoplastic fluororesin powder incorporated as the only resin powder in the rubber ingredient. The thermoplastic fluororesin powder has been incorporated in an amount of 1-80 parts by mass per 100 parts by mass of the rubber ingredient. The thermoplastic fluororesin powder has an average particle diameter of 0.1-20 um.

### TECHNICAL FIELD

The present invention relates to a cleaning blade for use in an image-forming apparatus. More particularly, the cleaning blade is formed by molding a thermoplastic elastomer containing a rubber component and resin powder added thereto.

### BACKGROUND ART

In an electrostatic photocopying machine, a copying operation is performed by applying an electrostatic charge to the surface of a photoreceptor by discharge, exposing an image onto the photoreceptor to form an electrostatic latent image thereon, attaching toner having an opposite polarity to the electrostatic latent image to develop the electrostatic latent image, transferring a toner image to recording paper, and heating the recording paper to which the toner image has been transferred under pressure to fix the toner to the recording paper. Therefore to sequentially copy the image of an original document on a plurality of sheets of the recording paper, it is necessary to remove the toner which remains on the surface of the photoreceptor after the toner image is transferred to the recording paper from the photoreceptor in the above-described processes. As a method of removing the toner which remains on the surface of the photoreceptor drum, a blade cleaning method of removing toner by sliding a cleaning blade on the surface of the photoreceptor drum, with the cleaning blade being pressed against the surface of the photoreceptor drum is known. As the material of the cleaning blade for use in the blade cleaning method, an elastic member is preferably used.

The cleaning blade composed of polyurethane rubber is conventionally used for the image-forming apparatus to clean pulverized toner or deformed polymerized toner present on the photoreceptor. The cleaning blade composed of the urethane rubber has the problem that it has a low heat resistance and that the edge thereof important in cleaning the toner wears and rounds because of the friction between it and the photoreceptor and is thus incapable of removing the toner with age. Even though the contact pressure (hereinafter referred to as line pressure) of the edge of the cleaning blade against the photoreceptor is low, the cleaning blade composed of polyurethane rubber is capable of cleaning the conventional pulverized toner or the deformed polymerized toner. Therefore the development of a material having a higher wear resistance than the polyurethane rubber has not been progressed.

Because the present tendency is to save energy, reduce the cost, and form a high-quality image, spherical small-diameter polymerized toner has been developed. As a result, unless the line pressure is increased, it is difficult to remove toner that remains on the surface of the photoreceptor, which causes defective cleaning to be liable to occur.

When the conventional cleaning blade composed of the polyurethane rubber is so constructed that it has a large line pressure, it has a large frictional force and thus the edge thereof wears to a high extent. Therefore it is difficult to increase the line pressure of the cleaning blade composed of the polyurethane rubber.

The cleaning blade composed of polyurethane rubber has another problem that it generates a squeal phenomenon caused by sliding vibration at a high temperature and a high humidity.

A demand for a decrease of the coefficient of friction has grown for the development of a measure of decreasing the wear of the edge and suppressing the squeal generated thereby.

To achieve a low coefficient of friction, a cleaning blade having a multilayered construction and a cleaning blade having a coated or modified surface are known.

For example, in Japanese Patent Application Laid-Open No. 2003-103686, description is made that by forming the layer made of the flexible diamond-like carbon (FDLC) on the edge of the cleaning blade made of the polyurethane rubber by means of a plasma enhanced chemical vapor deposition, it is possible to achieve a low coefficient of friction and obtain a cleaning blade superior in its wear resistance without deteriorating the basic property of the elastic body composing the base material thereof. The FDLC layer achieves the low coefficient of friction and improves the squeal phenomenon caused by the sliding vibration.

But the FDLC is attached to only the edge. Further because the FDLC insufficiently adheres to the polyurethane rubber, the FDLC is incapable of following the deformation of the edge. Thus there is a possibility that the FDLC peels off the polyurethane rubber. Therefore it is not admitted that the durability and wear resistance of the edge are sufficient in practical use. Further to form the FDLC layer on the elastic body which is the base material of the cleaning blade, it is necessary to perform the plasma enhanced chemical vapor deposition. Thus the above-described cleaning blade has a problem that the production process management is complicated and the production cost is high.

The cleaning blade having the multilayered construction has also a problem that the production cost is high and it is difficult to perform mass production.

Patent Document 1: Japanese Patent Application Laid-Open No. 2003-103686

### DISCLOSURE OF THE INVENTION

### Problem to be Solved by the Invention

It is an object of the present invention to provide a cleaning blade, for use in an image-forming apparatus, which is capable of displaying excellent cleaning performance by lowering a coefficient of friction thereof to decrease a slip distance in a stick-to-slip behavior of an edge thereof and which can be produced easily and inexpensively.

### Means for Solving the Problem

To solve the above-described problems, the present invention provides a cleaning blade, for use in an image-forming apparatus, which is formed from a thermoplastic elastomer comprising a rubber component consisting of one kind selected from the group consisting of a hydrogenated acrylonitrile-butadiene rubber (HNBR), a carboxyl group-introduced acrylonitrile-butadiene rubber (XNBR), a carboxyl group-introduced and hydrogenated acrylonitrile-butadiene rubber (HXNBR), a styrene-butadiene rubber (SBR), and an ethylene-propylene-diene copolymer rubber (EPDM) and only thermoplastic fluororesin powder added to the rubber component as resin powder, wherein not less than 1 part by mass nor more than 80 parts by mass of the thermoplastic fluororesin powder is added to 100 parts by mass of the rubber component; and an average particle diameter of the thermoplastic fluororesin powder is not less than 0.1 μm nor more than 20 μm.

FIG. 1 shows the behavior of the edge of the cleaning blade for use in the image-forming apparatus which occurs when the edge thereof is brought into contact with a rotating photoreceptor. Initially, (A)→(B) in FIG. 1 shows a stick state in which a cleaning blade piece 10 moves relative to a photoreceptor 12. At this time, the repulsive force F of the blade the coefficient of static friction Fs. The distance between positions P0 and P1 of the photoreceptor 12 shows a stick distance L1. The repulsive force F of the blade gradually increases. When the repulsive force F of the blade>the coefficient of static friction Fs, the cleaning blade piece 10 returns to its original position with the cleaning blade piece 10 sliding on the surface of the photoreceptor 12. A state (B)→(C) in FIG. 1 is a slip state. While the cleaning blade piece 10 is sliding, a load W is decreasingly applied to the photoreceptor and thus a coefficient of kinetic friction Fk becomes smaller. Thus slip of toner is liable to occur. The distance between positions P0 and P2 of the photoreceptor 12 shows a slip distance L2. As the cleaning blade piece 10 approaches the position P0 of the photoreceptor, the load W is increasingly applied to the photoreceptor until its original load is applied thereto. As a result, the repulsive force F of the blade=the coefficient of kinetic friction Fk. Then the coefficient of static friction Fs is generated again. Thereby the state of the cleaning blade piece 10 transits to a stick state. This state is a re-stick state shown by (C)→(A).

Based on the analysis of the above-described behavior of the edge of the cleaning blade, the present inventors have made energetic investigations to decrease the period of time of the slip state by decreasing the coefficient of friction and found that the above-described object is achieved by the cleaning blade composed of the thermoplastic elastomer in which only the thermoplastic fluororesin powder having the specific particle diameter is added to the specific rubber component as the resin powder and that the cleaning blade is capable of displaying an excellent cleaning performance in the conducted cleaning tests.

It is preferable that the rubber component to be used in the present invention consists of any one of the hydrogenated acrylonitrile-butadiene rubber (HNBR), the carboxyl group-introduced acrylonitrile-butadiene rubber (XNBR), the carboxyl group-introduced and hydrogenated acrylonitrile-butadiene rubber (HXNBR), the styrene butadiene rubber (SBR), and the ethylene-propylene-diene copolymer rubber (EPDM).

In the thermoplastic elastomer composing the cleaning blade of the present invention for use in the image-forming apparatus, only the thermoplastic fluororesin is added to the rubber component as the resin powder.

The mixing amount of the thermoplastic fluororesin powder for 100 parts by mass of the rubber component is not less than 1 part by mass nor more than 80 parts by mass and favorably not less than 5 parts by mass nor more than 70 parts by mass. When the mixing amount of the thermoplastic fluororesin powder is less than 1 part by mass, it is difficult to obtain the effect of decreasing the coefficient of friction. On the other hand, when the mixing amount thereof exceeds 80 parts by mass, the thermoplastic fluororesin powder becomes defects in the rubber. Thus there is a fear that the wear resistance deteriorates.

The average particle diameter of the thermoplastic fluororesin powder is not less than 0.1 μm nor more than 20 μm.

This is because when the average particle diameter thereof is less than 0.1 μm, defective dispersion occurs and thus it is difficult to obtain the effect of decreasing the coefficient of friction. On the other hand, when the average particle diameter thereof is more than 20 μm, the thermoplastic fluororesin powder becomes defects in the rubber. Thus there is a fear that the wear resistance deteriorates.

The average particle diameter of the thermoplastic fluororesin powder is favorably not less than 1.0 μm nor more than 15 μm, more favorably not less than 1.0 μm nor more than 10 μm, and most favorably not less than 1.0 μm nor more than 5 μm.

As the thermoplastic fluororesin powder to be used in the present invention, it is possible to use polymers having a carbon chain in its main chain and fluorine coupling in its side chain without restriction. Specifically it is preferable that the thermoplastic fluororesin powder consists of one or a plurality of kinds selected from the group consisting of tetrafluoroethylene (PTFE) resin powder, tetrafluoroethylene·perfluoroalkylvinyl ether (PFA) resin powder, tetrafluoroethylene·hexafluoropropylene·perfluoroalkylvinyl ether (EPE) resin powder, tetrafluoroethylene·hexafluoropropylene (FEP) resin powder, tetrafluoroethylene·ethylene (ETFE) resin powder, trifluorochloroethylene (CTFE) resin powder, trifluorochloroethylene·ethylene (ECTFE) resin powder, polyvinyl fluoride (PVF) resin powder, and polyvinylidene fluoride (PVDF) resin powder.

It is possible to use any of the above-described resins produced by various polymerization methods such as a catalyst emulsion polymerization, a suspension polymerization, a catalyst solution polymerization, a gas phase polymerization, and a ionizing radiation irradiation polymerization. Products commercially available can be utilized. For example, “Zonyl series” which is PFA produced by DuPont-Mitsui Fluorochemicals Company, Ltd., “Teflon (registered trademark) FEP100” which is FEP produced by DuPont-Mitsui Fluorochemicals Company, Ltd., “Afton COP” which is ETFE produced by Asahi Glass Co., Ltd., “Neoflon CTFE” which is CTFE produced by Daikin Industries, Ltd., “KF polymer which is PVDF produced by Kureha Chemical Co., Ltd, and “Tedlar” which is PVF produced by DuPont Kabushiki Kaisha are listed.

In addition to the rubber component and the thermoplastic fluororesin powder, the thermoplastic elastomer composing the cleaning blade of the present invention for use in the image-forming apparatus may contain known additives, unless the use of the additives is contrary to the object of the present invention. As the additives, a reinforcing agent, a crosslinking agent, a co-crosslinking agent, a vulcanization accelerator, a vulcanization accelerating auxiliary, an age resistor, and a softener for rubber are listed.

It is especially preferable that the thermoplastic elastomer contains 0.1 to 100 parts by mass of the reinforcing agent consisting of carbon black in addition to the rubber component and the thermoplastic fluororesin powder and a filler containing the crosslinking agent, the vulcanization accelerator, the vulcanization accelerating auxiliary, and the age resistor and that the total of the mixing amount of the filler for 100 parts by mass of the rubber component is 0.5 to 90 parts by mass.

The cleaning blade, of the present invention for use in the image-forming apparatus, composed of the above-described thermoplastic elastomer is characterized in that it has low friction-coefficient characteristics.

As indexes of the low friction-coefficient characteristics, the coefficient of static friction of the cleaning blade is not more than 2.0, and the coefficient of kinetic friction thereof is not more than 0.7.

When the coefficient of static friction is more than 2.0 and when the coefficient of kinetic friction is more than 0.7, the slip state shown in FIG. 1 continues long, and thus the slip amount of toner becomes large. It is preferable that the cleaning blade has the lowest possible coefficient of static friction and coefficient of kinetic friction, but normally the coefficient of static friction is not less than 1.0, and the coefficient of kinetic friction is not less than 0.1.

The coefficient of friction is measured by the method described in the example of the present invention.

To allow the cleaning blade of the present invention for use in the image-forming apparatus to display excellent cleaning performance, a slip distance in a stick-to-slip behavior which occurs when an edge of the cleaning blade is brought into contact with a photoreceptor which rotates at 200 mm/second is 1 μm to 100 μm.

It is preferable that the slip distance is 1 to 80 μm. When the slip distance is less than 1 μm, the cleaning blade is hard and is thus incapable of following irregularities of the photoreceptor. Thus expected cleaning performance cannot be obtained. On the other hand, when the slip distance is more than 100 μm, the stick-to-slip behavior becomes large, which may generate defective cleaning performance.

The slip distance is measured by the method described in the examples of the present invention.

It is preferable that the cleaning blade of the present invention has a thickness of 1 mm to 3 mm, a width of 10 mm to 40 mm, and a length of 200 mm to 500 mm.

It is preferable that the edge of the cleaning blade contacts the photoreceptor at 10° to 35°.

### Effect of the Invention

Because the cleaning blade of the present invention for the image-forming apparatus contains the rubber component consisting of any one of the HNBR, the XNBR, the HXNBR, the SBR, and the EPDM and the thermoplastic fluororesin powder having the specified particle diameter at the specified ratio, the cleaning blade has a low coefficient of static friction and a low coefficient of kinetic friction. Further it is possible to decrease the slip distance of the edge of the cleaning blade in the stick-to-slip behavior of the edge thereof. Consequently the cleaning blade is capable of displaying excellent cleaning performance.

Because the cleaning blade of the present invention for the image-forming apparatus is obtained by carrying out a normal method of molding the thermoplastic elastomer obtained by kneading the rubber component and the thermoplastic fluororesin powder, it is possible to produce the cleaning blade inexpensively and easily by utilizing existing equipment.

### BRIEF DESCRIPTION OF THE DRAWINGS

FIG. 1 is an illustration for explaining a stick-to-slip behavior of an edge of a cleaning blade which occurs when the edge thereof contacts a rotating photoreceptor.

FIG. 2 is a sectional illustration showing the cleaning blade of the present invention for use in an image-forming apparatus.

FIG. 3 is an illustrative view showing a color image-forming apparatus where the cleaning blade of the present invention is mounted.

FIG. 4 explains a method of measuring a coefficient of friction.

FIG. 5 explains a measuring apparatus for measuring a slip distance.

### EXPLANATION OF REFERENCE NUMERALS AND SYMBOLS

1: cleaning blade for use in image-forming apparatus
10: cleaning blade piece
11: charging roller
12: photoreceptor
13: intermediate transfer belt
14: fixing roller
15: toner
16: mirror
17: laser
18: to-be-transferred material
19a, 19b: transfer roller
21: supporting member
22: toner collection box

### BEST MODE FOR CARRYING OUT THE INVENTION

An embodiment of the cleaning blade of the present invention for use in an image-forming apparatus is described in detail below.

FIG. 2 shows a cleaning blade 1 of the present invention. In the cleaning blade 1, normally a cleaning blade piece 10 is bonded to a supporting member 21 with an adhesive agent. The supporting member 21 is composed of a rigid metal, an elastic metal, plastic or ceramic. The supporting member 21 is favorably made of metal and especially favorably made of Chrome-free SECC.

As the adhesive agent for bonding the cleaning blade piece 10 and the supporting member 21 to each other, a polyamide or polyurethane hot-melt adhesive agent and an epoxy or phenol adhesive agent are exemplified. It is preferable to use the hot-melt adhesive agent.

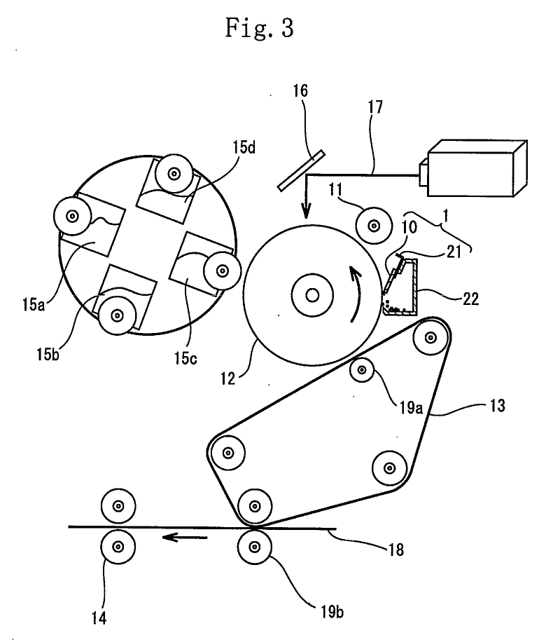

FIG. 3 shows an image-forming apparatus where the cleaning blade 1 of the present invention is mounted. In FIG. 3, 11 denotes a charging roller, 12 denotes a photoreceptor, 13 denotes an intermediate transfer belt, 14 denotes a fixing roller, 15a through 15d denote toner, 16 denotes a mirror, 17 denotes a laser, 18 denotes a to-be-transferred material, 19a denotes a primary transfer roller, 19b denotes a secondary transfer roller, and 22 denotes a toner collection box.

In the image-forming apparatus shown in FIG. 3, an image is formed through the following steps.

Initially, the photoreceptor 12 rotates in the direction shown with the arrow of FIG. 3. After the photoreceptor 12 is charged by the charging roller 11, the laser 17 exposes a non-imaging portion of the photoreceptor 12 via the mirror 16, thus destaticizing the non-imaging portion. At this time, a portion of the photoreceptor 12 corresponding to an imaging portion is charged. Thereafter the toner 15a is supplied to the photoreceptor 12 and attaches to the charged imaging portion to form a first-color toner image. The toner image is transferred to the intermediate transfer belt 13 via the primary transfer roller 19a. In the same manner, a toner image of each of the other color toners 15b through 15d formed on the photoreceptor 12 is transferred to the intermediate transfer belt 13. A full-color image composed of the four color toners 15 (15a through 15d) is formed on the intermediate transfer belt 13. The full-color image is transferred to the to-be-transferred material (normally, paper) 18 via the secondary transfer roller 19b. When the to-be-transferred material 18 passes between a pair of the fixing rollers 14 heated to a predetermined temperature, the full-color image is fixed to the surface thereof.

At the above-described steps, to sequentially copy the image of an original document on a plurality of sheets of the recording paper, toner which has not been transferred to the intermediate transfer belt 13 but has remained on the photoreceptor 12 is removed from the surface of the photoreceptor 12 by rubbing the photoreceptor 12 with the cleaning blade piece 10 of the cleaning blade 1 pressed against the surface of the photoreceptor 12 and is collected in the toner collection box 22.

The cleaning blade of the present invention is formed by molding the thermoplastic elastomer in which only the thermoplastic fluororesin powder is added to the rubber component as the resin powder.

The rubber component consists of any one of HNBR, XNBR, HXNBR, SBR, and EPDM. It is preferable to use the HNBR or HXNBR.

The HNBR is obtained by chemically hydrogenating the double bonds contained in butadiene present in the polymer main chain of NBR. It is preferable to use the HNBR having the residual double bonds not more than 10% after hydrogenation.

The bound acrylonitrile amount of the HNBR is favorably 21% to 46% and more favorably 21% to 44%. The reason the bound acrylonitrile amount of the HNBR is set to 21% to 46% is because when the bound acrylonitrile amount thereof is less than 21%, the mechanical property deteriorates. When the bound acrylonitrile amount of the HNBR is more than 46%, the glass transition temperature Tg of the thermoplastic elastomer becomes high, and thus the cleaning performance at low temperature and humidity is liable to deteriorate.

The Mooney viscosity ML1+4 (100° C.) of the HNBR is favorably 20 to 160 and more favorably 40 to 150. The reason the Mooney viscosity ML1+4 (100° C.) of the HNBR is set to 20 to 160 is because when the Mooney viscosity ML1+4(100° C.) thereof is less than 20, the molecular weight decreases and the wear resistance is liable to deteriorate. When the Mooney viscosity ML1+4(100° C.) of the HNBR is more than 160, it is difficult to perform kneading and molding operations owing to an excessive molecular weight distribution.

The XNBR is obtained by terpolymerizing acrylic acid or methacrylic acid as the third component of the NBR to introduce a carboxyl group into the side chain or the terminal thereof. A chemical formula 1 shown below indicates the chemical structural formula of the NBR. A chemical formula 2 shown below indicates the chemical structural formula of the XNBR obtained by terpolymerizing the acrylic acid (R=H) or the methacrylic acid (R=CH₃) as the third component of the NBR to introduce the carboxyl group into the side chain or the terminal thereof.

The HXNBR is obtained by chemically hydrogenating double bonds contained in butadiene present in the polymer main chain of the XNBR.

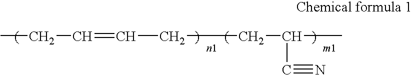

(In the formula 1, n1 and m1 indicate integers not less than 1.)

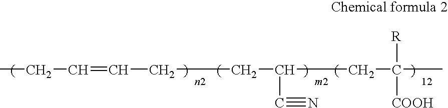

(In the formula 2, n2, m2, and 12 indicate integers not less than 1, and R indicates H or methyl group (CH₃).)

It is favorable that in the carboxyl group-introduced XNBR and HXNBR, the content ratio of the carboxyl group is set to 0.5 to 30 percent by mass. When the content ratio of the carboxyl group is less than 0.5 percent by mass, the extent of reactivity in the crosslinking is low. On the other hand, when the content ratio of the carboxyl group is more than 30 percent by mass, the carboxyl group makes an excessive reaction and scorching occurs. Thus there is a fear that the mechanical property deteriorates. The content ratio of the carboxyl group is more favorably 10 to 20 percent by mass.

As the XNBR and the HXNBR, it is possible to use commercially available products produced by polymerization. For example, it is possible to use Krynac series and Therban series produced by Bayer Corporation.

It is necessary that the SBR is a copolymer of a styrene monomer and a butadiene monomer. The SBR may contain other monomers copolymerizable with the styrene monomer and the butadiene monomer. Regarding the property of the SBR such as a styrene content, any kind of the SBR can be used. For example, the SBR having a bound styrene content of 10 to 30% is preferable. As the synthesizing method of the SBR, emulsion polymerization or solution polymerization may be used.

The EPDM rubber to be used in the present invention includes an oil-unextended type consisting of a rubber component and an oil-extended type containing the rubber component and extended oil. Both types can be used in the present invention. As examples of the diene monomer of the EPDM rubber, dicyclopentadiene, methylene norbornene, ethylidene norbornene, 1,4-hexadiene, and cyclooctadiene are listed.

As the thermoplastic fluororesin powder to be used in the present invention, PTFE resin powder is most favorable.

It is especially favorable that the average particle diameter of the thermoplastic fluororesin powder is not less than 1.0 μm nor more than 5 μm.

The mixing amount of the thermoplastic fluororesin powder for 100 parts by mass of the rubber component is more favorably 1 to 50 parts by mass and most favorably 5 to 30 parts by mass.

In addition to the rubber component and the thermoplastic fluororesin powder, the thermoplastic elastomer composing the cleaning blade, of the present invention, for use in the image-forming apparatus may contain known additives such as a reinforcing agent, a crosslinking agent, co-crosslinking agent, a vulcanization accelerator, a vulcanization accelerating auxiliary, a age resistor, and a softener for rubber are listed, unless the use of the additives is contrary to the object of the present invention. It is preferable that the thermoplastic elastomer contains the reinforcing agent, the crosslinking agent, the vulcanization accelerator, a vulcanization accelerating auxiliary, and the age resistor.

As the reinforcing agent, carbon black is used as a filler for causing an interaction of the carbon black and the rubber.

As the carbon black, it is possible to use SAF carbon (average particle diameter: 18 to 22 nm), SAF-HS carbon (average particle diameter: about 20 nm), ISAF carbon (average particle diameter: 19 to 29 nm), N-339 carbon (average particle diameter: about 24 nm), ISAF-LS carbon (average particle diameter: 21 to 24 nm), I-ISAF-HS carbon (average particle diameter: 21 to 31 nm), HAF carbon (average particle diameter: about 26 to 30 nm), HAF-HS carbon (average particle diameter: 22 to 30 nm), N-351 carbon (average particle diameter: about 29 nm), HAF-LS carbon (average particle diameter: about 25 to 29 nm), LI-HAF carbon (average particle diameter: about 29 nm), MAF carbon (average particle diameter: 30 to 35 nm), FEF carbon (average particle diameter: about 40 to 52 npm), SRF carbon (average particle diameter: 58 to 94 nm), SRF-LM carbon, and GPF carbon (average particle diameter: 49 to 84 nm) are listed.

The thermoplastic elastomer may contain inorganic reinforcing agents such as white carbon (silica filler such as dry silica and wet silica, silicate such as magnesium silicate), calcium carbonate, magnesium carbonate, magnesium silicate, clay (aluminum silicate), silane-modified clay, and talc; and organic reinforcing agents such as coumarone and indene resin, phenol resin, high styrene resin, and wood meal as the reinforcing agent.

The mixing amount of the reinforcing agents for 100 parts by mass of the rubber component is favorably 0.1 to 100 parts by mass, more favorably 1 to 70 parts by mass, and most favorably 1 to 50 parts by mass.

As the crosslinking agent, sulfur, an organic peroxide, a heat-resistant crosslinking agent, and a resin crosslinking agent are listed. It is favorable to use the sulfur and the organic peroxide. It is more favorable to use the sulfur.

The sulfur is used by pulverizing recovered sulfur to use it in the form of fine powder. Surface-treated sulfur having improved dispersibility can be appropriately used. Insoluble sulfur can be also used to prevent blooming from occurring from unvulcanized rubber.

The sulfur may be used in combination with an organic sulfur-containing compound. As the organic sulfur-containing compounds, N,N′-dithiobismorpholine, diphenyl disulfide, pentabromo disulfide, pentachlorothiophenol, and zinc pentachlorothiophenolate are listed. The diphenyl disulfide is especially favorable.

As the organic peroxides, benzoyl peroxide, 1,1-di-(tert-butyl peroxy)-3,3,5-trimethylcyclohexane, 2,5-dimethyl-2,5-di-(benzoyl peroxy)hexane, 2,5-dimethyl-2,5-di-(benzoyl peroxy)-3-hexene, 2,5-dimethyl-2,5-di-(tert-butyl peroxy)hexane, di-tert-butyl peroxy-diisopropylbenzene, di-tert-butyl peroxide, di-tert-butyl peroxybenzoate, dicumyl peroxide, tert-butyl cumyl peroxide, 2,5-dimethyl-2,5-di-(tert-butyl peroxy)-3-hexene, 1,3-bis(tert-butyl peroxyisopropyl)benzene, n-butyl-4,4-bis(tert-butyl peroxy)valerate, p-chlorobenzoyl peroxide, 2,4-dichlorobenzoyl peroxide, tert-butyl peroxyisopropyl carbonate, diacetyl peroxide, and lauroyl peroxide are listed. The dicumyl peroxide is especially favorable.

As the heat-resistant crosslinking agent, 1,3-bis(citraconimide methyl)benzene, hexamethylene-1,6-sodium bisthiosulfate·dihydrate, and 1,6-bis(dibenzylthiocarbamoyl disulfide)hexane are listed.

As the resin crosslinking agent, alkylphenol resin such as TACKIROL 201 and TACKIROL 250-III (produced by TAOKA CHEMICAL CO., LTD.), and HITANOL 2501 (produced by Hitachi Chemical Co., Ltd.) or brominated alkylphenol formaldehyde resin are listed. The alkylphenol resin is especially preferable.

The mixing amount of the crosslinking agent should be large enough to allow the property of the rubber component to be sufficiently displayed. Normally the mixing amount of the crosslinking agent for 100 parts by mass of the rubber component is selected favorably in the range of 0.1 parts by mass to 30 parts by mass. More specifically, as the mixing amount of the sulfur for 100 parts by mass of the rubber component, the sulfur is added to the rubber component favorably at a ratio of 0.1 parts by mass to 20 parts by mass, more favorably at a ratio of 0.1 parts by mass to 10 parts by mass, and most favorably at a ratio of 0.1 parts by mass to 5 parts by mass. As the mixing amount of the organic peroxide for 100 parts by mass of the rubber component, the organic peroxide is added to the rubber component favorably at a ratio of 0.1 parts by mass to 20 parts by mass, more favorably at a ratio of 0.1 parts by mass to 10 parts by mass, and most favorably at a ratio of 0.1 parts by mass to 5 parts by mass.

As the vulcanizing accelerator, both inorganic and organic vulcanizing accelerators can be used.

As the inorganic vulcanizing accelerator, slaked lime, magnesium oxide, titanium oxide, and litharge (PbO) are listed.

As the organic vulcanizing accelerator, thiurams, thiazoles, thioureas, dithiocarbamates, guanidines, and sulfinamides are listed.

As the thiurams, tetramethylthiuram monosulfide, tetramethylthiuram disulfide, tetraethylthiuram disulfide, tetrabutylthiuram disulfide, and dipentamethylenethiuram tetrasulfide are listed.

As the thiazoles, 2-mercaptobenzothiazole, dibenzothiazyl disulfide, N-cyclohexyl benzothiazole, N-cyclohexyl-2-benzothiazolesulfenamide, N-oxydiethylene-2-benzothiazolesulfenamide, N-tert-butyl-2-benzothiazolesulfenamide, and N,N-dicyclohexyl-2-benzothiazolesulfenamide are listed.

As the thioureas, N,N′-diethylthiourea, ethylenethiourea, and trimethylthiourea are listed.

As the dithiocarbamates, zinc dimethyl dithiocarbamate, zinc diethyl dithiocarbamate, zinc dibutyl dithiocarbamate, sodium dimethyl dithiocarbamate, sodium diethyl dithiocarbamate, copper dimethyl dithiocarbamate, ferric dimethyl dithiocarbamate (III), selenium diethyl dithiocarbamate, and tellurium diethyl dithiocarbamate are listed.

As the guanidine accelerator, di-o-tolylguanidine, 1,3-diphenylguanidine, 1-o-tolylbiguanide, and di-o-tolylguanidine salts of dicatechol borate are listed.

As the sulfenamides, N-cyclohexyl-2-benzothiazylsulfenamide is exemplified.

These vulcanizing accelerators may be used singly or in combination of not less than two kinds.

As the vulcanizing accelerator, it is especially preferable to use the dibenzothiazyl disulfide or/and the tetramethylthiuram monosulfide.

The mixing amount of the vulcanization accelerator for 100 parts by mass of the rubber component is favorably 0.1 parts by mass to 15 parts by mass, more favorably 0.1 parts by mass to 10 parts by mass, and most favorably 0.5 parts by mass to 5 parts by mass.

As the vulcanization accelerating auxiliary, metal oxides such as zinc oxide, magnesium oxide, aluminum oxide, copper oxide, ferric oxide, nickel oxide, calcium oxide, sodium oxide, and lead oxide are listed. The zinc oxide is especially preferable. These metal oxides may be used singly or in combination of not less than two kinds.

The mixing amount of the metal oxide to be used as the vulcanization accelerating auxiliary for 100 parts by mass of the rubber component is favorably 0.1 to 30 parts by mass, more favorably 1 to 15 parts by mass, and most favorably 1 to 10 parts by mass. When the mixing amount of the metal oxide is less than 0.1 parts by mass, the metal oxide is incapable of providing a sufficient effect as the vulcanization accelerating auxiliary and complying with expectation of improving the mechanical property. On the other hand, when the mixing amount of the metal oxide is more than 30 parts by mass, it is difficult to finely disperse the metal oxide.

Known vulcanization accelerating auxiliaries other than the metal oxide may be used in combination. As the vulcanization accelerating auxiliary other than the metal oxide, fatty acids such as stearic acid, oleic acid, and cottonseed fatty acid are listed. The mixing amount of the vulcanization accelerating auxiliary is not limited to a specific amount, but may be appropriately selected according to the kind thereof. For example, the mixing amount of the vulcanization accelerating auxiliary for 100 parts by weight of the rubber component is favorably 0.1 parts by mass to 20 parts by mass and more favorably 0.1 parts by mass to 10 parts by mass.

The age resistor is an additive for preventing oxidative deterioration, heat deterioration, ozone deterioration, and fatigue deterioration called aging. The age resistor is classified into a primary age resistor including amines, phenols, and the like and a secondary age resistor including sulfur compounds, phosphites, and the like. The primary age resistor has the function of donating hydrogen to various polymer radicals to stop a chain reaction of auto-oxidation. The secondary age resistor shows a stabilizing action by changing hydroxy peroxides into stable alcohols.

Because in recent years, the cleaning blade for use in the image-forming apparatus is exposed to various environments, it is necessary to take measures for preventing the cleaning blade from aging. A polymer is destroyed by the friction between a photoreceptor and the cleaning blade. Radicals generated by the destruction of the polymer accelerate an automatic oxidative reaction. The wear of the cleaning blade is accelerated by the oxidative deterioration. Therefore it is necessary to take measures of preventing the cleaning blade from being subjected to the oxidative deterioration. Because the cleaning blade is subjected to a high temperature, it is also important to prevent the cleaning blade from being thermally deteriorated. Because ozone is generated by a charging mechanism, it is necessary to take measures of preventing the cleaning blade from being deteriorated by ozone. Therefore by combining several kinds of age resistors with one another, it is possible to prevent the above-described deteriorations. It is very important for the thermoplastic elastomer composing the cleaning blade to contain the age resistor to the rubber component for preventing the edge of the cleaning blade from being worn by the oxidative deterioration.

As the age resistor, amines, phenols, imidazoles, and phosphorus-containing substances, and thioureas are listed.

As the amines, phenyl-α-naphthylamine, 2,2,4-trimethyl-1,2-dihydroquinoline polymer, 6-ethoxy-2,2,4-trimethyl-1,2-dihydroquinoline, p,p′-dioctyldiphenylamine, p,p′-dicumyldiphenylamine, N,N′-di-2-naphthyl-p-phenylenediamine, N,N′-diphenyl-p-phenylenediamine, N-phenyl-N′-isopropyl-p-phenylenediamine, and N-phenyl-N′-1,3-dimethylbutyl-p-phenylenediamine are listed.

As the phenols, 2,6-di-tert-butyl-4-methylphenol; styrenated methylphenol; 2,2′-methylenebis(4-ethyl-6-tert-butyl phenol); 2,2′-methylenebis(4-methyl-6-tert-butylphenol); 4,4′-butylidenebis (3-methyl-6-tert-butylphenol); 4,4′-thiobis(3-methyl-6-tert-butylphenol); 2,5-di-tert-butylhydroquinone; and 2,5-di-tert-amylhydroquinone are listed.

As the imidazoles, 2-mercaptobenzimidazole, zinc salts of the 2-mercaptobenzimidazole, and nickel dibutyldithiocarbamate are listed.

As other age resistors, it is possible to use phosphorus-containing substances such as tris(nonylphenyl)phosphite; thioureas such as 1,3-bis(dimethylaminopropyl)-2-thiourea, tributyl thiourea, and the like; and wax for preventing ozone deterioration.

These age resistors can be used singly or in combination of not less than two kinds thereof.

It is especially preferable to use the p,p′-dicumyldiphenylamine or/and 2-mercaptobenzoimidazole.

It is preferable that the mixing amount of the age resistor for 100 parts by mass of the rubber component is 0.1 to 15 parts by mass. When the mixing amount of the age resistor is less than 0.1 parts by mass, the effect of preventing aging is not displayed. Thus there is a fear that deterioration and wear of the mechanical property progress outstandingly. When the mixing amount of the age resistor exceeds 15 parts by mass, defective dispersion occurs owing an excessive use thereof. Thus there is a fear that the mechanical property deteriorates. The mixing amount of the age resistor for 100 parts by mass of the rubber component is more favorably 0.1 to 10 parts by mass and most favorably 0.5 to 5 parts by mass.

The co-crosslinking agent is referred to as an agent crosslinking itself and reacting with rubber molecules to crosslink them, thus making the entire elastomer polymeric. As the co-crosslinking agent, ethylenically unsaturated monomers represented by methacrylate ester, metal salts of methacrylic acid or acrylic acid, polyfunctional polymers, and dioximes are listed.

As the ethylenically unsaturated monomer, (a) monocarboxylic acids such as acrylic acid, methacrylic acid, crotonic acid, and the like, (b) dicarboxylic acids such as maleic acid, fumaric acid, itaconic acid, and the like, (c) ester or anhydride of the unsaturated carboxylic acids of the above-described (a) and (b), (d) metal salts of (a) through (c), (e) aliphatic conjugated diene such as 1,3-butadiene, isoprene, 2-chloro-1,3-butadiene, and the like, (f) aromatic vinyl compounds such as styrene, α-methylstyrene, vinyl toluene, ethylvinyl benzene, divinylbenzene, and the like, (g) vinyl compounds such as triallyl isocyanurate, triallyl cyanurate, and vinylpyridine having a complex ring, (h) vinyl cyanide compounds such as (meta)acrylonitrile and α-chloroacrylonitrile, acrolein, formylstyrol, vinyl methyl ketone, vinyl ethyl ketone, and vinyl butyl ketone are listed.

As a softener for rubber, derivatives of phthalic acid, isophthalic acid, adipic acid, sebacic acid, benzoic acid, and phosphoric acid are listed.

More specifically, dioctyl phthalate (DOP) such as dibutyl phthalate (DBP) and di-(2-ethylhexyl) phthalate; diisooctyl phthalate (DIOP), higher alcohol-phthalate, di-(2-ethylhexyl) sebacate, polyester adipate, dibutyl diglycol adipate, di(butoxyethoxyethyl) adipate, isooctyl-tall oil fatty ester, tributyl phosphate (TBP), tributoxyethyl phosphate (TBEP), tricresyl phosphate (TCP), cresyl-diphenyl phosphate (CDP), and diphenyl alkane are listed. These softeners for rubber can be used singly or in combination of not less than two kinds thereof.

The mixing amount of the softener for rubber should be large enough to allow the property of the rubber component to be sufficiently displayed. The mixing amount of the softener for rubber is selected in the range of 0 to 5 parts by mass for 100 parts by mass of the rubber component as occasion demands.

As other additives, amide compounds, fatty acids, metal salts of the fatty acids, and wax are listed.

As the amide compounds, aliphatic amide compounds and aromatic amide compounds are listed. As fatty acids of the aliphatic amide compounds, oleic acid, stearic acid, erucic acid, caproic acid, caprilic acid, capric acid, lauric acid, myristic acid, palmitic acid, arachidic acid, behenic acid, palmitoleic acid, eicosenoic acid, erucic acid, elaidic acid, trans-11-eicosane acid, trans-13-docosenoic acid, linolic acid, linolenic acid, and ricinoleic acid are listed. As the aliphatic amide compounds, ethylene-bis-erucamide, ethylene-bis-oleamide, ethylene-bis-stearamide, oleamide, stearamide, erucamide, and behenamide are listed. The oleamide, the stearamide, and the erucamide are especially preferable.

As fatty acids, lauric acid, stearic acid, palmitic acid, myristic acid, and oleic acid are listed. As the metal salts of the fatty acids, metal salts of the fatty acids and zinc, iron, calcium, aluminum, lithium, magnesium, strontium, barium, cerium, titanium, zirconium, lead, and manganese are listed.

As the wax, paraffin wax, montan wax, and amide wax are listed.

The mixing amount of these additives should be large enough to allow the property of the rubber component to be sufficiently displayed. In the present invention, the mixing amount of the additives for 100 parts by mass of the rubber component is selected in the range of 0 to 10 parts by mass.

The cleaning blade of the present invention for use in the image-forming apparatus can be produced by using known methods. The following producing method is exemplified.

Initially the thermoplastic elastomer composing the cleaning blade of the present invention for use in the image-forming apparatus is formed. The thermoplastic elastomer can be obtained by mixing the above-described components with one another with a kneading apparatus such as a single-axis extruder, a 1.5-axis extruder, a biaxial extruder, an open roll, a kneader, a Banbury mixer or a heated roller. The order of mixing the components is not specifically limited, but it is possible to supply the components to the kneading apparatus all together. It is also possible to supply a part of the components to the kneading apparatus and knead them in advance to obtain a mixture, add remaining components to the obtained mixture, and perform a kneading operation again. It is preferable to carry out a method of kneading the components other than the crosslinking agent in advance to obtain a mixture, add the crosslinking agent to the obtained mixture, and thereafter kneading all the components.

The cleaning blade of the present invention for use in the image-forming apparatus is obtained by molding the obtained thermoplastic elastomer by using known molding methods such as compression molding or injection molding.

More specifically the following producing method is exemplified.

Initially components other than the crosslinking agent are kneaded with a kneading apparatus such as a single-axis extruder, a 1.5-axis extruder, a biaxial extruder, an open roll, a kneader, a Banbury mixer or a heated roller. The kneading temperature is 80° C. to 120° C. The kneading period of time is five to six minutes. When the kneading temperature is less than 80° C. and when the kneading period of time is less than five minutes, the rubber component is insufficiently plasticized, and the kneading is liable to be insufficiently performed. When the kneading temperature is more than 120° C. and when the kneading period of time is more than six minutes, there is a fear that the rubber component is decomposed.

After the crosslinking agent is added to the obtained mixture, all the components are kneaded with the kneading apparatus described above. The kneading temperature is 80° C. to 90° C. The kneading period of time is five to six minutes. When the kneading temperature is less than 80° C. and when the kneading period of time is less than five minutes, the mixture is insufficiently plasticized and kneaded. When the kneading temperature is more than 90° C. and when the kneading period of time is more than six minutes, there is a fear that the crosslinking agent is decomposed.

The cleaning blade of the present invention is formed by molding the thermoplastic elastomer obtained by carrying out the above-described method. It is preferable to mold and process the thermoplastic elastomer composition into the rectangular cleaning blade having a thickness of 1 mm to 3 mm, a width of 10 mm to 40 mm, and a length of 200 mm to 500 mm. It is preferable that the edge of the cleaning blade contacts the photoreceptor at 10° to 35°.

The molding method is not limited to a specific method, but a known method such as injection molding or compression molding can be used. For example, a method of press-vulcanizing the thermoplastic elastomer set in a die at 155° C. to 175° C. for 10 to 30 minutes is exemplified. When the vulcanizing temperature is less than 155° C. and when the vulcanizing period of time is less than 10 minutes, shortage of vulcanization occurs. When the vulcanizing temperature is more than 175° C. and when the vulcanizing period of time is more than 30 minutes, there is a fear that scorching occurs.

The cleaning blade of the present invention obtained by carrying out the above-described method has a coefficient of static friction not less than 1.0 nor more than 2.0 and a coefficient of kinetic friction not less than 0.3 nor more than 0.7. A slip distance in a stick-to-slip behavior which occurs when an edge of the cleaning blade is brought into contact with a photoreceptor which rotates at 200 mm/second is 10 to 100 μm, favorably 30 to 100 μm.

The cleaning performance value of the cleaning blade of the present invention measured after a paper feed test is conducted by mounting it on the image-forming apparatus is not more than 0.5. The reason the cleaning performance value of the cleaning blade of the present invention is set to not more than 0.5 is because when the cleaning performance value thereof is more than 0.5, the slip amount of toner becomes large. Thus there is a fear that a printed image is adversely affected. It is preferable that the cleaning performance value infinitely approaches zero, but the lower limit thereof is normally not less than 0.1. That the cleaning performance value is zero means that toner is all removed from the surface of the photoreceptor. The cleaning blade whose cleaning performance value is zero has the most favorable cleaning performance.

The cleaning performance value is measured and evaluated in the following manner after the paper feed test is conducted by mounting the cleaning blade on the image-forming apparatus.

Initially the paper feed test is conducted. More specifically, a cleaning blade punched in a predetermined size out of a sheet, made of the thermoplastic elastomer composition, which has a thickness of 2 mm is bonded to a supporting member. Thereafter the cleaning blade is mounted on the image-forming apparatus with the cleaning blade in contact with the photoreceptor. The image-forming apparatus is a printer in which the photoreceptor rotates and toner can be developed. Polymerized spherical toner having a volume average particle diameter of 5 to 10 μm and a spherical degree of 0.90 to 0.99 is used. At a temperature of 23° C. and a relative humidity of 55%, a 4% image is printed on 150,000 sheets of paper by setting the rotational speed of the photoreceptor to 200 mm to 500 mm/second.

After the paper feed test finishes, the amount of toner present on the photoreceptor per unit area is computed beforehand to obtain a toner amount Ta before the toner slips the cleaning blade. The photoreceptor is rotated to remove the toner by the cleaning blade. Thereafter the amount of the toner which is present on the surface of the photoreceptor and disposed rearward from the cleaning blade is converted into an amount per unit area to obtain a toner amount Tb which has slipped the cleaning blade. The ratio of the toner amount Tb which has slipped the cleaning blade to the toner amount Ta before the toner slips the cleaning blade is the cleaning performance value.

Examples of the present invention and comparison examples are described below.

### EXAMPLES 1 THROUGH 9 AND COMPARISON EXAMPLES 1 THROUGH 7

After the mixing amount of each of the rubber component, the PTFE resin powder or the ETFE resin powder both of which are the thermoplastic fluororesin powder, and the fillers shown in tables 1 and 2 was measured as shown in tables 1 and 2, the components were supplied to a rubber kneading apparatus such as a biaxial extruder, an open roll, a Banbury mixer or a kneader. Thereafter they were kneaded for five to six minutes while they were being heated to 80° C. to 120° C.

The obtained mixture and the crosslinking agent, the mixing amount of which is shown in tables 1 and 2 were supplied to the rubber kneading apparatus such as the open roll, the Banbury mixer or the kneader. Thereafter they were kneaded for five to six minutes while they were being heated to 80° C. to 90° C.

After each of obtained thermoplastic elastomers was set in a die, it was press-vulcanized at 155° C. to 175° C. for 10 to 30 minutes to obtain a sheet having a thickness of 2 mm.

A sheet having a thickness of 2 mm was cut to obtain the cleaning blade piece of each of the examples and the comparison examples having a width of 20 mm and a length of 320 mm. Each cleaning blade piece was bonded to a supporting member made of chrome-free SECC with hot-melt (made of diamond). The central portion of the sheet was cut to obtain each cleaning blade.

TABLE 1

| | | Comparison | Comparison | Comparison | Comparison | Comparison | Comparison | Comparison |
|---|---|---|---|---|---|---|---|---|
| | | Example1 | Example2 | Example3 | Example4 | Example5 | Example6 | Example7 |
| Rubber | SBR | 100 | | | | | 100 | 100 |
| component | NBR | | 100 | | | | | |
| | EPDM | | | 100 | | | | |
| | HNBR | | | | 100 | | | |
| | XNBR | | | | | | | |
| | HXNBR | | | | | 100 | | |
| Fluororesin | PTFE resin powder | | | | | | 0.5 | 100 |
| powder | ETFE resin powder | | | | | | | |
| Filler | Carbon black | 20 | 20 | 20 | 20 | 20 | 20 | 20 |
| | Zinc oxide | 5 | 5 | 5 | 5 | 5 | 5 | 5 |
| | Stearic acid | 1 | 1 | 1 | 1 | 1 | 1 | 1 |
| | Age resistor A | 1 | 1 | 1 | 1 | 1 | 1 | 1 |
| | Age resistor B | 2 | 2 | 2 | 2 | 2 | 2 | 2 |
| | Vulcanization | 1.5 | 1.5 | | 1.5 | 1.5 | 1.5 | 1.5 |
| | accelerator A | | | | | | | |
| | Vulcanization | 0.5 | 0.5 | | 0.5 | 0.5 | 0.5 | 0.5 |
| | accelerator B | | | | | | | |
| Crosslinking | Sulfur | 1.5 | 1.5 | | 1.5 | 1.5 | 1.5 | 1.5 |
| agent | Organic peroxide | | | 2.4 | | | | |

| | | | | | | | |
|---|---|---|---|---|---|---|---|
| Coefficient of static friction | 4.2 | 5.3 | 3.5 | 4.5 | 3.6 | 2.3 | 0.9 |
| Coefficient of kinetic friction | 1.5 | 1.7 | 1.2 | 1.6 | 1.2 | 0.9 | 0.3 |
| Slip distance (μm) | 250 | 283 | 210 | 280 | 232 | 120 | 65 |
| Cleaning performance | 1.2 | 1.3 | 1.0 | 1.2 | 1.1 | 0.7 | 1.5 |
| Overall judgment | X | X | X | X | X | X | X |

TABLE 2

| | | Example1 | Example2 | Example3 | Example4 | Example5 | Example6 | Example7 | Example8 | Example9 |
|---|---|---|---|---|---|---|---|---|---|---|
| Rubber | SBR | 100 | 100 | 100 | 100 | | | | | 100 |
| component | NBR | | | | | | | | | |
| | EPDM | | | | | 100 | | | | |
| | HNBR | | | | | | 100 | | | |
| | XNBR | | | | | | | | 100 | |
| | HXNBR | | | | | | | 100 | | |
| Fluororesin | PTFE resin powder | 1 | 20 | 50 | 80 | 20 | 20 | 20 | 20 | |
| powder | ETFE resin powder | | | | | | | | | 20 |
| Filler | Carbon black | 20 | 20 | 20 | 20 | 20 | 20 | 20 | 20 | 20 |
| | Zinc oxide | 5 | 5 | 5 | 5 | 5 | 5 | 5 | 5 | 5 |
| | Stearic acid | 1 | 1 | 1 | 1 | 1 | 1 | 1 | 1 | 1 |
| | Age resistor A | 1 | 1 | 1 | 1 | 1 | 1 | 1 | 1 | 1 |
| | Age resistor B | 2 | 2 | 2 | 2 | 2 | 2 | 2 | 2 | 2 |
| | Vulcanization | 1.5 | 1.5 | 1.5 | 1.5 | | 1.5 | 1.5 | 1.5 | 1.5 |
| | accelerator A | | | | | | | | | |
| | Vulcanization | 0.5 | 0.5 | 0.5 | 0.5 | | 0.5 | 0.5 | 0.5 | 0.5 |
| | accelerator B | | | | | | | | | |
| Crosslinking | Sulfur | 1.5 | 1.5 | 1.5 | 1.5 | | 1.5 | 1.5 | 1.5 | 1.5 |
| agent | Organic peroxide | | | | | 2.4 | | | | |

| | | | | | | | | | |
|---|---|---|---|---|---|---|---|---|---|
| Coefficient of static friction | 2.0 | 1.8 | 1.5 | 1.3 | 1.8 | 1.3 | 1.1 | 1.5 | 1.7 |
| Coefficient of kinetic friction | 0.7 | 0.6 | 0.5 | 0.4 | 0.7 | 0.4 | 0.3 | 0.5 | 0.6 |
| Slip distance (μm) | 95 | 90 | 83 | 75 | 89 | 73 | 64 | 81 | 89 |
| Cleaning performance | 0.45 | 0.43 | 0.42 | 0.40 | 0.43 | 0.35 | 0.29 | 0.40 | 0.43 |
| Overall judgment | ◯ | ◯ | ◯ | ◯ | ◯ | ⊚ | ⊚ | ⊚ | ◯ |
| [symbol] | | | | | | | | | |

The unit of the mixing amount of each of the rubber component, the thermoplastic fluororesin powder, the filler, and the crosslinking agent shown in tables 1 and 2 is part by mass.

The following products were used for the following components of all the components shown in table 1:
SBR: “1502 (commercial name)” produced by JSR Corporation (bound styrene amount: 23.5%)
EPDM: “Esprene 670F (commercial name)” produced by Sumitomo Chemical Co., Ltd.
HNBR: “Zetpol 2010H (commercial name)” produced by Zeon Corporation (bound acrylonitrile amount: 36%, Mooney viscosity: 145)
XNBR: “Krynac X750 (commercial name)” produced by Bayer Corporation
HXNBR: “Therban XT VPKA8889 (commercial name)” produced by Bayer Corporation
PTFE resin powder: “Zonyl TLP10E-1 (commercial name)” produced by DuPont-Mitsui Fluorochemicals Company, Ltd. (primary particle diameter: 0.2 μm, average particle diameter: 2.0 to 4.0 μm)
ETFE resin powder: “Fluon ETFE Z-8820X (commercial name)” (average particle diameter: 5 to 30 μm)
Carbon black: “SEAST ISAF (commercial name)” produced by Tokai Carbon Co., Ltd.
Zinc oxide: “Two kinds of zinc oxide (commercial name)” produced by Mitsui Mining and Smelting Co., Ltd.
Stearic acid: “Tsubaki (commercial name)” produced by NOF CORPORATION
Age resistor A: p,p′-dicumyldiphenylamine, (“Nocrac CD” (commercial name) produced by Ouchishinko Chemical Industrial Co., Ltd.)
Age resistor B: 2-mercaptobenzimidazole, (“Nocrac MB” (commercial name) produced by Ouchishinko Chemical Industrial Co., Ltd.)
Vulcanization accelerator A: dibenzothiazyl sulfide (“Nocceler DM” (commercial name) produced by Ouchishinko Chemical Industrial Co., Ltd.)
Vulcanization accelerator B: tetramethylthiuram monosulfide (“Nocceler TS” (commercial name) produced by Ouchishinko Chemical Industrial Co., Ltd.)
Sulfur: powder sulfur produced by Tsurumi Chemical Industry Co., Ltd.
Organic peroxide: dicumyl peroxide (PERCUMYL D (commercial name) produced by NOF CORPORATION

The following tests were conducted on the obtained cleaning blades.

### (1) Measurement of Coefficient of Friction

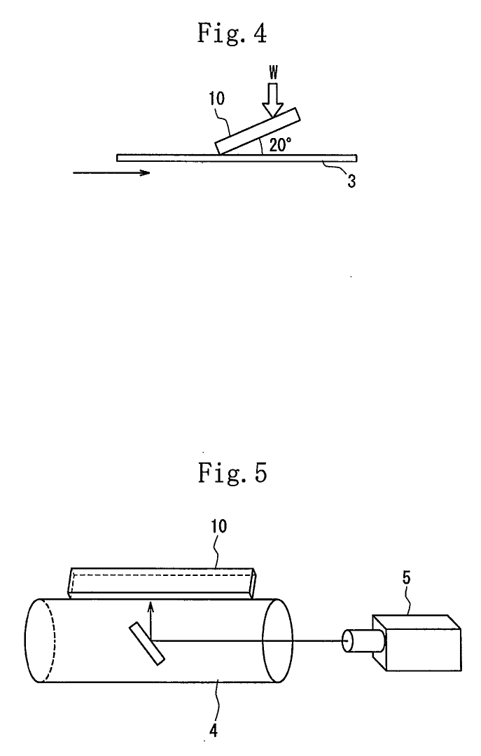

As shown in FIG. 4, a cleaning blade piece 10 having a width of 20 mm was mounted on an unshown surface property measurement device (“Type 14” produced by Shinto Scientific Co., Ltd.) at an angle of 20° before the cleaning blade piece 10 was bonded to a supporting member. With a load W (60 gf) being applied to the cleaning blade piece 10, a glass substrate (hereinafter referred to as “OPC-applied glass”) 3 to which a photosensitive material was applied was moved relative to the cleaning blade piece 10 at a moving speed of 100 mm/second by a counter method (direction shown with arrow in FIG. 4) to compute the coefficient of static friction and coefficient of kinetic friction of the cleaning blade piece 10 from the sliding resistance thereof. The coefficient of static friction and the coefficient of kinetic friction were measured at five times. The average value of three values except the maximum and minimum values was set as the value of the coefficient of static friction and the coefficient of kinetic friction.

### (2) Measurement of Slip Distance

The cleaning blade of each of the examples and the comparison examples was mounted on an image-forming apparatus (produced by the present applicant) in which a photoreceptor rotates and toner can be developed.

A transparent columnar glass 4 having 30 was prepared. The same transparent material as the surface material of the photoreceptor was applied to the surface of the columnar glass 4. The columnar glass 4 was mounted on the image-forming apparatus as the photoreceptor thereof.

As shown in FIG. 5, a high-speed camera 5 set alongside the columnar glass 4 is capable of photographing the behavior of the edge of the cleaning blade owing to the refraction of light inside the columnar glass 4. The high-speed camera 5 used was “FASTCAM-APX-RS-250K” produced by Photron Inc.

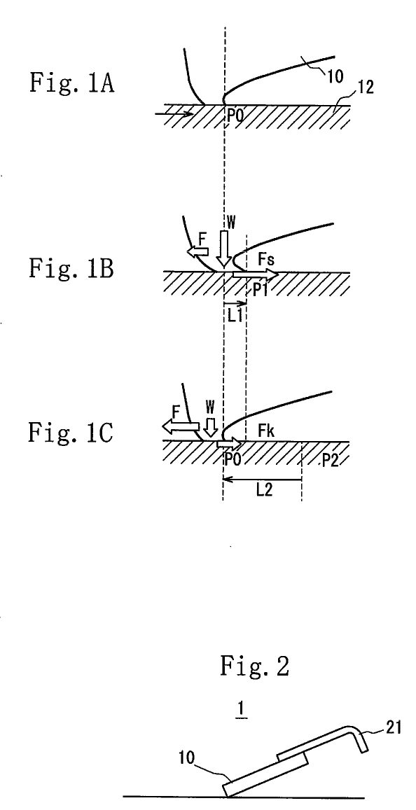

The behavior of the edge was photographed when the columnar glass 4 was rotated at a line speed of 200 mm/second. As the photographing conditions, the photographing speed was 10,000 fps, and an exposure time was 10 μs. As shown in FIG. 1, the slip distance was computed from images.

The test was conducted at a normal temperature of 23° C. and a relative humidity of 55%.

### (3) Evaluation of Cleaning Performance

The cleaning blade of each of the examples and the comparison examples was mounted on an image-forming apparatus (produced by the present applicant) in which the photoreceptor rotates and the toner can be developed. Polymerized spherical toner having a volume average particle diameter of 5 to 10 μm and a spherical degree of 0.90 to 0.99 was used.

A 4% image was printed on 150,000 sheets of paper in a condition in which the rotational speed of the photoreceptor was set to 200 mm to 500 mm/second. The amount of the toner (toner amount Ta before toner slips cleaning blade) present on the photoreceptor per unit area was computed beforehand. The photoreceptor was rotated to remove the toner by the cleaning blade. Thereafter the amount of the toner present on the surface of the photoreceptor and disposed rearward from the cleaning blade was converted into an amount per unit area. In this manner, a toner amount Tb which slipped the cleaning blade was obtained. From the obtained values, the cleaning performance value was computed based on the following equation:

Cleaning performance value=(toner amount Tb which has slipped cleaning blade)/(toner amount Ta before toner slips cleaning blade).

The test was conducted at a normal temperature of 23° C. and a relative humidity of 55%.

### (4) Overall Evaluation

Cleaning blades having the coefficient of static friction not more than 2.0 and the coefficient of kinetic friction not more than 0.7 have low friction property. In the evaluation of the cleaning performance, cleaning blades having the cleaning performance value not more than 0.5 are excellent in the cleaning performance thereof.

Taking these values in consideration, excellent cleaning blades were marked by “ ”. Good cleaning blades were marked by “·”. Inferior cleaning blades were marked by “X”.

Each of the comparison examples 1 through 5 not containing the thermoplastic fluororesin powder had large coefficient of static friction and coefficient of kinetic friction and a long slip distance. Therefor the slip amount of toner was large and inferior in its cleaning performance.

The comparison example 6 containing a small amount of the thermoplastic fluororesin powder was improved in its coefficient of static friction and coefficient of kinetic friction and slip distance over those of the comparison examples 1 through 5, but was not sufficient in its cleaning performance.

The comparison example 7 which contained a large amount of the thermoplastic fluororesin powder had a poor wear resistance because the thermoplastic fluororesin powder became defects in the rubber. Consequently the comparison example 7 had a low cleaning performance.

On the other hand, each of the examples 1 through 9 had a low coefficient of static friction and a low coefficient of kinetic friction and a short slip distance and thus had excellent cleaning performance.

1-6. (canceled)

7. A cleaning blade for use in an image-forming apparatus, which is formed from a thermoplastic elastomer comprising a rubber component consisting of one kind selected from the group consisting of a hydrogenated acrylonitrile-butadiene rubber (HNBR), a carboxyl group-introduced acrylonitrile-butadiene rubber (XNBR), a carboxyl group-introduced and hydrogenated acrylonitrile-butadiene rubber (HXNBR), a styrene-butadiene rubber (SBR), and an ethylene-propylene-diene copolymer rubber (EPDM) and only thermoplastic fluororesin powder added to said rubber component as resin powder,
wherein not less than 1 part by mass nor more than 80 parts by mass of said thermoplastic fluororesin powder is added to 100 parts by mass of said rubber component; and an average particle diameter of said thermoplastic fluororesin powder is not less than 0.1 μm nor more than 20 μm.

8. The cleaning blade for use in an image-forming apparatus according to claim 7, wherein a slip distance in a stick-to-slip behavior which occurs when an edge of said cleaning blade is brought into contact with a photoreceptor which rotates at 200 mm/second is 1 to 100 μm.

9. The cleaning blade for use in an image-forming apparatus according to claim 7, wherein a coefficient of static friction is not less than 1.0 nor more than 2.0; and a coefficient of kinetic friction is not less than 0.1 nor more than 0.7.

10. The cleaning blade for use in an image-forming apparatus according to claim 7, wherein said thermoplastic fluororesin powder consists of one or a plurality of kinds selected from the group consisting of tetrafluoroethylene (PTFE) resin powder, tetrafluoroethylene·perfluoroalkylvinyl ether (PFA) resin powder, tetrafluoroethylene·hexafluoropropylene·perfluoroalkylvinyl ether (EPE) resin powder, tetrafluoroethylene·hexafluoropropylene (FEP) resin powder, tetrafluoroethylene·ethylene (ETFE) resin powder, trifluorochloroethylene (CTFE) resin powder, trifluorochloroethylene·ethylene (ECTFE) resin powder, polyvinyl fluoride (PVF) resin powder, and polyvinylidene fluoride (PVDF) resin powder.

11. The cleaning blade for use in an image-forming apparatus according to claim 7, wherein in addition to said rubber component and said thermoplastic fluororesin powder, said thermoplastic elastomer contains 0.1 to 100 parts by mass of a reinforcing agent consisting of carbon black for 100 parts by mass of said rubber component and contains a filler containing a crosslinking agent, a vulcanization accelerator, a vulcanization accelerating auxiliary, and an age resistor; and a total of a mass of said filler is 0.5 to 90 parts by mass for 100 parts by mass of said rubber component.

12. The cleaning blade for use in an image-forming apparatus according to claim 7, having a thickness of 1 mm to 3 mm, a width of 10 mm to 40 mm, and a length of 200 mm to 500 mm.

13. The cleaning blade for use in an image-forming apparatus according to claim 8, wherein a coefficient of static friction is not less than 1.0 nor more than 2.0; and a coefficient of kinetic friction is not less than 0.1 nor more than 0.7.

14. The cleaning blade for use in an image-forming apparatus according to claim 8, wherein said thermoplastic fluororesin powder consists of one or a plurality of kinds selected from the group consisting of tetrafluoroethylene (PTFE) resin powder, tetrafluoroethylene·perfluoroalkylvinyl ether (PFA) resin powder, tetrafluoroethylene·hexafluoropropylene·perfluoroalkylvinyl ether (EPE) resin powder, tetrafluoroethylene·hexafluoropropylene (FEP) resin powder, tetrafluoroethylene·ethylene (ETFE) resin powder, trifluorochloroethylene (CTFE) resin powder, trifluorochloroethylene·ethylene (ECTFE) resin powder, polyvinyl fluoride (PVF) resin powder, and polyvinylidene fluoride (PVDF) resin powder.

15. The cleaning blade for use in an image-forming apparatus according to claim 9, wherein said thermoplastic fluororesin powder consists of one or a plurality of kinds selected from the group consisting of tetrafluoroethylene (PTFE) resin powder, tetrafluoroethylene·perfluoroalkylvinyl ether (PFA) resin powder, tetrafluoroethylene·hexafluoropropylene·perfluoroalkylvinyl ether (EPE) resin powder, tetrafluoroethylene·hexafluoropropylene (FEP) resin powder, tetrafluoroethylene·ethylene (ETFE) resin powder, trifluorochloroethylene (CTFE) resin powder, trifluorochloroethylene·ethylene (ECTFE) resin powder, polyvinyl fluoride (PVF) resin powder, and polyvinylidene fluoride (PVDF) resin powder.
